(19) United States
(12) Patent Application Publication
(10) Pub. No.: US 2003/0091701 A1
(43) Pub. Date: May 15, 2003

(54) Method and apparatus for processing wine

(76) Inventor: Shimon Yahav, Rehovot (IL)

Correspondence Address: LADAS & PARRY, 26 WEST 61ST STREET, NEW YORK, NY, 10023, US

(21) Appl. No.: 10/182,807

(22) PCT Filed: Jan. 22, 2001
(86) PCT No.: PCT/IL01/00061

(30) Foreign Application Priority Data
Feb. 1, 2000 (IL) 134318

(51) Int. Cl. A23B 4/00

(52) U.S. Cl. 426/112

(57) ABSTRACT

A method for processing wine, including filling a bottle with wine, capping the bottle with a bottle stopper, the bottle stopper including a valve that has a first orientation in which sediments can flow from the bottle past the valve, and a second orientation in which the valve substantially prevents re-entry of the sediments back into the bottle, producing sediments in the bottle, centrifugally forcing the sediments in the bottle towards the bottle stopper, the valve being in the first orientation so that the sediments flow past the valve and are removed from the bottle, and moving the valve to the second orientation to substantially prevent re-entry of the sediments back into the bottle. An apparatus for removing sediment is also disclosed.

### FIELD OF THE INVENTION

The present invention relates generally to apparatus and methods for production of effervescent beverages and particularly to apparatus and methods for efficient production-line bottling and riddling of sparkling or fortified wines, such as champagne

### BACKGROUND OF THE INVENTION

Sparkling wines, such as champagne, are classically produced by bottling wine before the fermentation has been completed and allowing the wine to finish fermentation, or to undergo a second fermentation, in the bottle. During fermentation in the bottle, grape sugar and/or sugar added to the wine are converted into alcohol and carbon dioxide. The presence of the CO₂ causes a relatively high pressure, for example, about 6 atmospheres and greater, to be built up in the hermetically closed bottle.

Besides the alcohol and CO₂ production, sediments are also produced during fermentation in the bottle, and these must be removed before the champagne or other beverage may be sold and consumed. The removal of these sediments constitutes a major problem. In order to remove the sediments from the bottle they are first collected upon the inside face of the cork of the bottle, whereafter the liquid in the neck of the bottle is frozen into solid state and finally the cork and the small block of ice containing the sediments are blown off with the aid of the gas pressure within the bottle. In order to avoid loss of liquid, immediately after removal of the sediments, the bottle must be hermetically closed again. In this step, as in the previous ones, great skill is required and, apart from the accidents that are liable to happen, losses of valuable liquid cannot be avoided in the period between the uncorking and the new sealing of the bottles. In addition, oxygen enters the wine during the period of uncorking, which adversely affects taste, quality and longevity of the wine. Typically liqueur, brandy and/or sugar are added to the wine to compensate for the wine lost during the removal of the frozen matter.

Several United States patents attempt to solve the sediment removal problem by providing a bottle stopper that entraps therein the sediments formed in the bottle during fermentation. U.S. Pat. No. 3,856,169 to Wilson et al. describes a bottle cap with an internal collection chamber which can be sealed by a probe extending inwards from the top of the cap. The bottle cap is screwed onto a matins threaded ring affixed around the neck of the bottle. After capping the bottle, the bottle is inverted and sediments are allowed to collect in the collection chamber. By turning the bottle cap, the position of the probe can be adjusted so as to seal the sediments collected in the collection chamber. However, the Wilson et al. bottle cap suffers from several disadvantages, e.g., the probe must be manually moved to seal the collection chamber, and it is difficult to ensure that the probe has been properly positioned to seal the chamber. The process is unsuitable for mass production.

U.S. Pat. No. 4,947,737 to Gladstone describes a double-chambered bottle cap. The bottle cap has a first chamber formed in the center of a first bulbous portion, which leads into a second chamber formed in the center of a second bulbous portion. The second portion is deformable. A stopper extends from the second portion into the first portion and is arranged to seal the second chamber. The bottle cap is sealingly placed in the neck of a bottle. The bottle is inverted and sediments pass through the first chamber and collect in the second chamber. A knife is then used to cut an annular slit around the junction of the second and first bulbous portions. This weakens the second portion. The internal gas pressure in the bottle pushes against the interior of the second chamber, thereby deforming and expanding the weakened second portion. As the second portion expands, the stopper moves therewith and seals the second chamber with the sediments collected therein. The knife can then be used to completely sever the second portion from the first portion, thereby discarding the sediments and leaving the first portion on the bottle which is sealed by the stopper. However, the Gladstone bottle cap suffers from several disadvantages, e.g., the need for cutting the bottle cap twice during the process makes the process cumbersome and unsuitable for mass production.

U.S. Pat. No. 4,932,543 to Martus describes a bottle cap with an internal collection chamber which can be sealed by a plunger. Once the bottle is capped, the bottle is inverted and sediments are allowed to collect in the collection chamber. The plunger can be manually pushed against a valve seat to seal the sediments collected in no the collection chamber. The Martus bottle cap improves on the abovementioned patents by permitting introduction of additives through the bottle cap. However, the Martus bottle cap suffers from several disadvantages e.g., the plunger must be manually moved to seal the collection chamber, making the can unsuitable for mass production.

Other relevant U.S. patents which are directed to bottle caps for collection therein of sediments include: U.S. Pat. No. 2,584,183 to Blumauer, U.S. Pat. No. 4,687,115 to Bongiovanní and Pat. No. 5,614,236 to Klang.

Published PCT Patent Application WO 98/51574 to Yahav, the disclosure of which is incorporated herein by reference, describes an improved bottle stopper for sediment collection which overcomes the drawbacks of the abovementioned patents. The Yahav bottle stopper has a collection receptacle formed therein, and a valve that permits flow of a fluid containing sediments from the bottle into the collection receptacle. The valve may be closed to substantially trap the sediments in the collection receptacle and obstruct flow therefrom to the bottle. A retaining mechanism is provided for releasably retaining the valve in an open configuration that permits the flow of the fluid containing sediments into the collection receptacle. A pressure relief device is provided that relieves an internal pressure of the bottle. An expelling device is provided for expelling sediments from the collection receptacle, preferably while the stopper is attached to the bottle. The stopper may be fashioned with a sealable spout to allow pouring contents from the bottle while the stopper is still attached thereto.

However, even with the abovementioned stoppers, the process of making sparkling or fortified wines, such as champagne, has not changed. In order to remove the sediments from the bottle, either by using the traditional freezing method or by collecting and trapping the sediments in the stopper, one must first have the sediments collect near or in the stopper. In order to accomplish this, one must still carefully riddle the wine, a process which takes a long time and requires skilled labor.

### SUMMARY OF THE INVENTION

The present invention seeks to provide novel apparatus and methods for efficient production-line bottling of sparkling or fortified wines, such as champagne. The apparatus and methods solve the abovementioned problem of the art by eliminating the riddling process altogether. Instead the wine is centrifuged to force the sediments towards a novel bottle stopper used to stop the bottle. The bottle stopper has a valve used to remove sediments from the bottle. The sediments are removed either by collecting and trapping them in the stopper, or by expelling them out of the bottle without collecting them in the stopper. In all cases, the stopper remains on the bottle until opened by a consumer. If desired, any additives can be added to the wine without removing the stopper. The invention permit vintners to effect improvements and saving in the entire, traditional processes of wine and champagne making. The invention improves the taste of the wine and increases its shelf-life.

In a preferred embodiment of the present invention, the stopper includes a safety, pressure relief valve. It is noted that in the prior art, champagne generally produces an internal pressure of about 6 bars (atmospheres) in the bottle. Glass bottles which can withstand pressures of about 15 bars cost about $0.50. However, because wine manufacturers must take into account a factor of safety, champagne bottles are generally selected to withstand internal gas pressures of about 25 atmospheres, such bottles costing about $1.20. The pressure relief valve of the present invention permits using the less expensive 15 bar bottles. Indeed the pressure relief valve even permits using bottles that withstand internal gas pressures of about 5-6 atmospheres. At such pressures, plastic bottles may be used instead of glass. The stopper itself can be inexpensively manufactured from plastic, for example.

The pressure relief valve also enables adding certain additives that may not be possible with the prior art. For example, substances, such as incompletely fermented wine, can be added that actually increase fermentation and production of sediments, thereby possibly enhancing aroma and taste. Such increased fermentation would not be desirable in the prior art because of the danger of exploding, the bottle, as well as the difficulty of extracting the excess sediments from the bottle. With the stopper and pressure relief valve of the present invention, these problems do not exist.

Another advantage of the pressure relief valve is that any extraneous oxygen is expelled from the bottle, thereby improving taste, aroma, quality and longevity.

The invention enables mass-production of wine about 76 times faster than production using prior art riddling machines. The process of the present invention permits moving the bottles in a production line during aging and storage in a wine cellar, thereby eliminating the need for storing the bottles in stacks or piles, and obviating any need for storage or transportation cages of the prior art.

In the prior art, the basic steps of champagne production may be summarized as follows:

1. Fill bottle with wine.

2. Close bottle with a first bottle stopper.

3. Transport bottle to wine cellar.

4. Place bottle in stacks or piles.

5. Age wine (typically for a minimum of one and a half years).

6. Place bottle in transportation cage and transport to riddling machine.

7. Automatic riddling of wine (typically one week).

8. Freezing of wine near stopper at neck of bottle.

9. Open stopper and remove frozen matter, thereby losing some of the wine.

10. Add additives to wine.

11. Close bottle with a second bottle stopper, different from first bottle stopper.

12. Close traditional wires about second bottle stopper.

13. Rinse bottle.

14. Dry bottle.

15. Place wrappers and labels.

In contrast, in the present invention, the above steps are reduced to the following:

1. Fill bottle with wine.

2. Close bottle with stopper (same stopper throughout process).

3. Transport bottle to wine cellar.

4. Age wine (typically for a minimum of one and a half years).

5. Transport bottle to sediment removal machine (no need for transportation cage).

6. Remove sediments, add additives (if desired), rinse bottle and dry bottle (all at one machine, as described further hereinbelow).

7. Place wrappers and labels.

It is noted that throughout the specification and claims the terms “effervescent beverage”, “fermented beverage”, “wine” and “champagne” are used interchangeably and encompass not only wine and champagne but also any kind of fermented beverage, including ciders, ales and beers, produced from any type of grain, fruit, legume or vegetable, for example, as well as any kind of liquid in which sediments form, such as pressed oils.

There is thus provided in accordance with a preferred embodiment of the present invention a method for processing wine, including filling a bottle with wine, capping the bottle with a bottle stopper, the bottle stopper including a valve that has a first orientation in which sediments can flow from the bottle past the valve, and a second orientation in which the valve substantially prevents re-entry of the sediments back into the bottle, producing sediments in the bottle, centrifugally forcing the sediments in the bottle towards the bottle stopper, the valve being in the first orientation so that the sediments flow past the valve and are removed from the bottle, and moving the valve to the second orientation to substantially prevent re-entry of the sediments back into the bottle.

In accordance with a preferred embodiment of the present invention the valve includes a collection receptacle and in the second orientation the valve traps the sediments in the collection receptacle. Alternatively, the valve permits expelling the sediments out of the bottle without collecting the sediments in the valve.

Further in accordance with a preferred embodiment of the present invention the method includes adding additives to the wine without removing the bottle stopper from the bottle.

Still further in accordance with a preferred embodiment of the present invention the method includes shearing off a rupturable head from the bottle stopper after the sediments have been removed from the bottle.

Additionally in accordance with a preferred embodiment of the present invention the method includes placing a final cap on the bottle stopper after shearing off the rupturable head, and placing a label on the bottle.

There is also provided in accordance with a preferred embodiment of the present invention a sediment removal machine including a centrifuge machine, and a plurality of bottle receiving members operative to securely hold a plurality of bottles lying flat on the table during high-speed rotation of the table, with bottle stoppers of the bottles pointing radially outwards from a center of the table.

In accordance with a preferred embodiment of the present invention a plurality of bottles are held on the table by the bottle receiving members.

Further in accordance with a preferred embodiment of the present invention each of the bottles includes a bottle stopper, the stopper including a valve that has a first orientation in which sediments can flow from the bottle past the valve, and a second orientation in which the valve substantially prevents re-entry of the sediments back into the bottle.

Still further in accordance with a preferred embodiment of the present invention the bottle stopper includes a pressure relief valve.

Additionally in accordance with a preferred embodiment of the present invention an actuator is operative to move the valve to at least one of the first and second orientations.

In accordance with a preferred embodiment of the present invention apparatus is provided for shearing off a rupturable head off the bottle stopper.

Further in accordance with a preferred embodiment of the present invention there is also provided apparatus for washing the bottles, apparatus for drying the bottles, and apparatus for adding a substance to the bottles without removing the stopper from the bottle.

There is also provided in accordance with a preferred embodiment of the present invention a bottle stopper including a collection receptacle that defines a volume for collecting and trapping therein sediments, a stem extending from the collection receptacle adapted to fit into a neck of a bottle, the stem being formed with a valve seat, and a plunger slidingly disposed in a guide member formed in the collection receptacle, the plunger including an end member disposed at an end of a shaft, the end member being arranged to sealingly seat against the valve seat, the shaft being formed with at least one axial groove so that air can freely pass from the guide member past the at least one groove into the volume. Preferably the plunger is biased against an inside surface of the collection receptacle by means of a biasing device.

There is also provided in accordance with a preferred embodiment of the present invention a stopper including a stem that can be sealingly inserted into a neck of a bottle, the stem including a valve seat formed at an end of a bore, a valve including a plunger disposed in the bore, the plunger being arranged to be selectively seated against the valve seat, the plunger being operative to substantially prevent passage of matter into the bore when seated against the valve seat, and to permit passage of matter into the bore when not seated against the valve seat, and a pressure relief valve having a channel open at an end of the plunger that extends into a passageway which fluidly communicates with the bore, the pressure relief valve including a sealing washer positioned between the channel and the passageway, the sealing washer permitting passage of matter from the channel to the passageway only when a pressure of a sufficient magnitude is applied thereagainst.

In accordance with a preferred embodiment of the present invention a cap is affixed to a top portion of the plunger, the cap being formed with at least one aperture in fluid communication with the bore, wherein the cap can be pressed to move the plunger away from the valve seat, thereby permitting egress of matter through the bore and the at least one aperture.

### BRIEF DESCRIPTION OF THE DRAWINGS

The present invention will be understood and appreciated more fully from the following detailed description, taken in conjunction with the drawings in which:

FIG. 1 is a simplified pictorial, partially sectional illustration of a bottle stopper constructed and operative in accordance with a preferred embodiment of the present invention;

FIG. 2 is a simplified sectional illustration of a distal ring of a plunger of the bottle stopper of FIG. 1, formed as an internally splined O-ring;

FIG. 3 is a simplified sectional illustration of a proximal ring of a bore of the bottle stopper of FIG. 1. formed as an extern ally splined O-ring;

FIG. 4 is a simplified pictorial, partially sectional illustration of the plunger of the bottle stopper being pushed to allow collected sediments to be expelled from a bootie, in accordance with a preferred embodiment of the present invention,

FIG. 5 is a simplified pictorial, partially sectional illustration of shearing off a rupturable head from the bottle stopper in accordance with a preferred embodiment of the present invention:

FIG. 6 is a simplified pictorial, partially sectional illustration of adding a substance to wine in the bottle in accordance with a preferred embodiment of the present invention;

FIG. 7 is a simplified pictorial, partially sectional illustration of adding a cap to the bottle stopper in accordance with a preferred embodiment of the present invention;

FIG. 8 is a simplified pictorial, partially sectional illustration of a pressure relief valve useful in the bottle stopper of FIG. 1, constructed and operative in accordance with a preferred embodiment of the present invention;

FIG. 9 is a simplified block diagram illustration of a method for production-line processing wine in accordance with a preferred embodiment of the present invention;

FIG. 10 is a simplified pictorial illustration of a sediment removal machine, constructed and operative in accordance with a preferred embodiment of the present invention, wherein wine bottles are moved manually from a conveyor belt onto a centrifuge machine;

FIG. 11 is a simplified pictorial illustration of the sediment removal machine of FIG. 10, wherein the bottles are fed from the conveyor belt onto the table by one or more manipulators;

FIG. 12 is a simplified pictorial illustration of centrifuging sediments in the bottles in accordance with a preferred embodiment of the present invention;

FIG. 13 is a simplified pictorial illustration of expelling the sediments from the bottles in accordance with a preferred embodiment of the present invention;

FIG. 14 is a simplified pictorial illustration of shearing a rupturable head off a plunger of the bottle stopper, in accordance with a preferred embodiment of the present invention;

FIG. 15 is a simplified pictorial illustration of washing the bottles in accordance with a preferred embodiment of the present invention;

FIG. 16 is a simplified pictorial illustration of drying the bottles in accordance with a preferred embodiment of the present invention;

FIG. 17 is a simplified pictorial illustration of adding a substance to the bottles in accordance with a preferred embodiment of the present invention;

FIG. 18 is a simplified pictorial illustration of adding a cap to a top portion of the bottle stopper in accordance with a preferred embodiment of the present invention;

FIGS. 19A, 19B and 19C are simplified pictorial illustrations of a stopper constructed and operative in accordance with an alternative embodiment of the present invention;

FIGS. 20A, 20B and 20C are simplified pictorial illustrations of a stopper constructed and operative in accordance with another alternative embodiment of the present invention; and

FIGS. 21A, 21B and 21C are simplified pictorial illustrations of a stopper constructed and operative in accordance with yet another alternative embodiment of the present invention.

### DETAILED DESCRIPTION OF A PREFERRED EMBODIMENT

Reference is now made to FIG. 1 which illustrates a bottle stopper 10 constructed and operative in accordance with a preferred embodiment of the present invention.

Stopper 10 may be fabricated from any durable material such as plastic, metal or cork (the illustrated embodiment), and may be transparent or opaque, and may be sealably attached to a bottle 12. Bottle 12 may be fabricated from materials such as glass, metal or plastic. It is appreciated that the present invention may be carried out with any container suitable for containing therein a beverage, such as a tank or metal container as well, and throughout the specification and the claims, the term “bottle” encompasses any such kind of container suitable for containing therein a beverage, and the terms are used interchangeably.

Stopper 10 preferably is formed with a central bore 14 and includes a stem 16 that can be sealingly inserted into a neck 18 of bottle 12. Stem 16 is preferably formed with a valve seat 17, which may be constructed of a different material than that of stem 16 if desired. (If stopper 10 and stem 16 are made of plastic, then valve seat 17 may be stem 16 itself.) Traditional wires 15 may, be provided, if desired, for eventual closing thereover at the end of the bottling process.

Stopper 10 is preferably provided with a valve 20 that, as will be described hereinbelow, permits expelling sediments and other unwanted matter from bottle 12. In accordance with one preferred embodiment of the present invention, valve 20 includes a plunger 22 comprising a distal portion 22A and a proximal portion 22B. Distal and proximal portions 22A and 22B may be formed separately and joined together, as in the illustrated embodiment, or alternatively may be formed as one integral piece. A rupturable head 23 preferably extends proximally from proximal portion 22B. An end 21 of distal portion 22A is preferably provided with an O-ring 25 for sealing against valve seat 17. End 21 is typically conical in shape, but it is appreciated that other shapes may also be used that sealingly seat against valve seat 17.

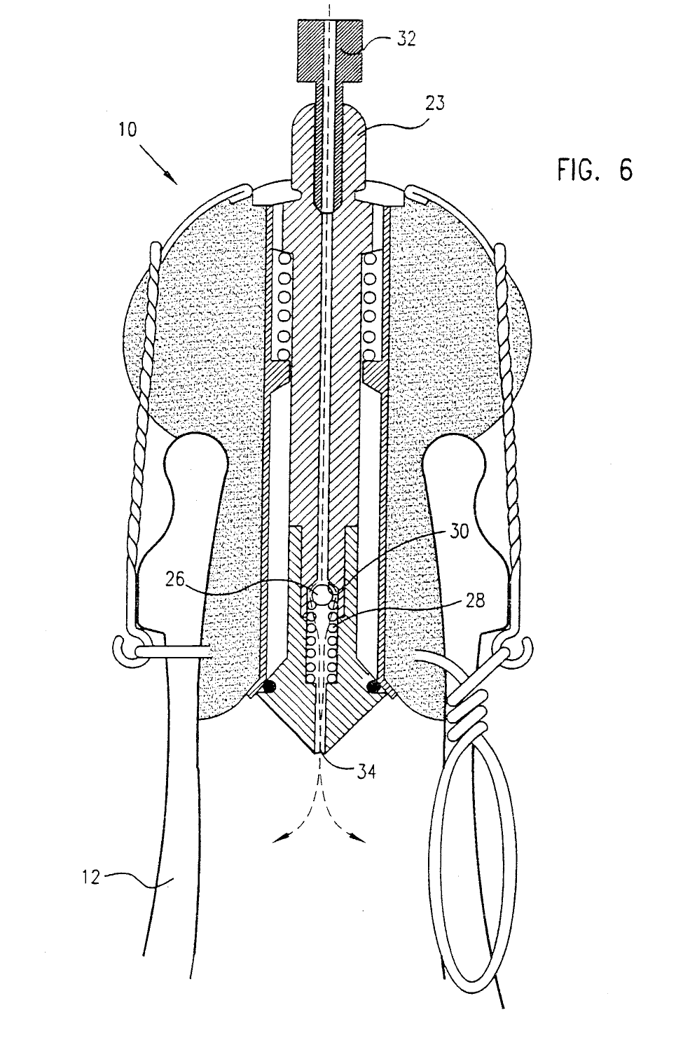

Plunger 22 is preferably formed with a longitudinal passageway 24, extending through distal and proximal portions 22A and 22B, for introduction of substances therethrough. A ball 26 is preferably positioned at a valve seat 30 formed along a portion of passageway 24 in distal portion 22A. A biasing device, such as a spring 28, is disposed in passageway 24 between ball 26 and a counterbore formed in the passageway. Spring 28 tends to push ball 26 against valve seat 30. If it is desired to add substances, such as sweeteners, flavorings or liqueur to the beverage in the bottle, these substances may be conveniently added by means of a syringe 32, as is described further hereinbelow with reference to FIG. 6. End 21 may be provided with a rupturable membrane 21A that normally prevents sediments and other foreign matter from entering passageway 24, but which can be ruptured by the force of syringe 32 pushing substances therethrough. Once membrane 21A has been ruptured, not only spring 28 but also the internal pressure of the contents of the bottle tend to push ball 26 against valve seat 30.

A biasing device 36, such as a coil spring, is preferably provided at proximal portion 22B of plunger 22. Biasing device 36 preferably biases against a distal ring 38 radially protruding inwards into bore 14, and applies an upward force against a proximal ring 40 radially extending from proximal portion 22B. Distal ring 38 is preferably formed as an internally splined O-ring, as seen in FIG. 2. Proximal ring 40 is preferably formed as an externally splined O-ring, as seen in FIG. 3. In this manner, fluid can freely flow between the proximal and distal ends of bore 14.

Referring again to FIG. 1, it is seen that sediments and other matter may collect in the vicinity of end 21 of plunger 22. (As will be described further hereinbelow, the sediments are formed during aging of the wine in the bottle 12, and are forced centrifugally towards the stopper 10 in accordance with the methods of the invention.) O-ring 25 sealingly presses against valve seat 17 and substantially prevents passage of the sediments therepast.

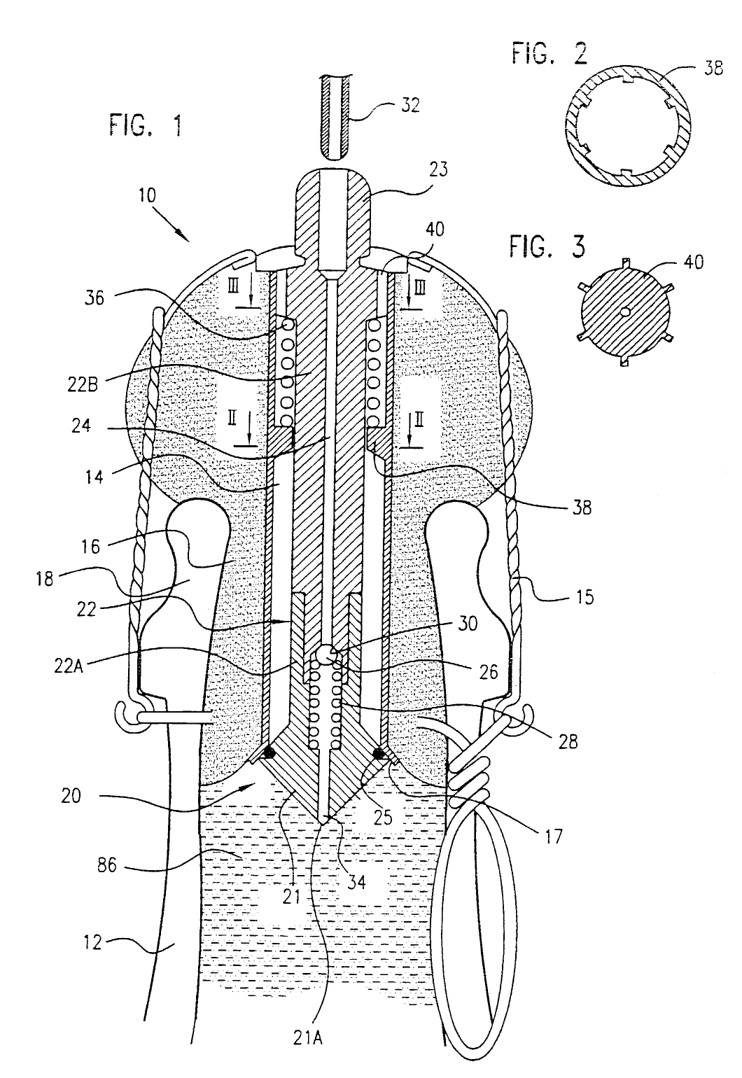

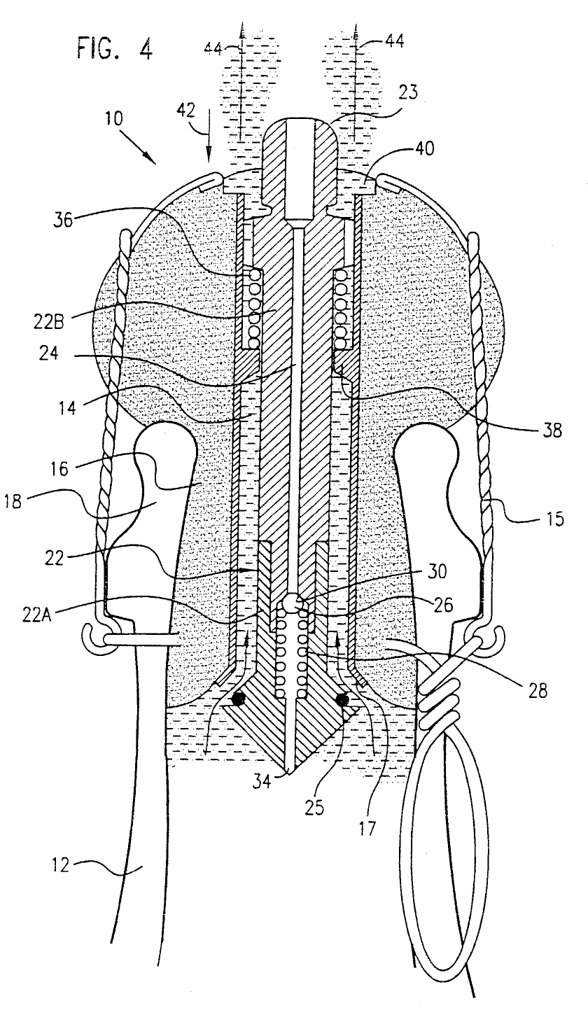

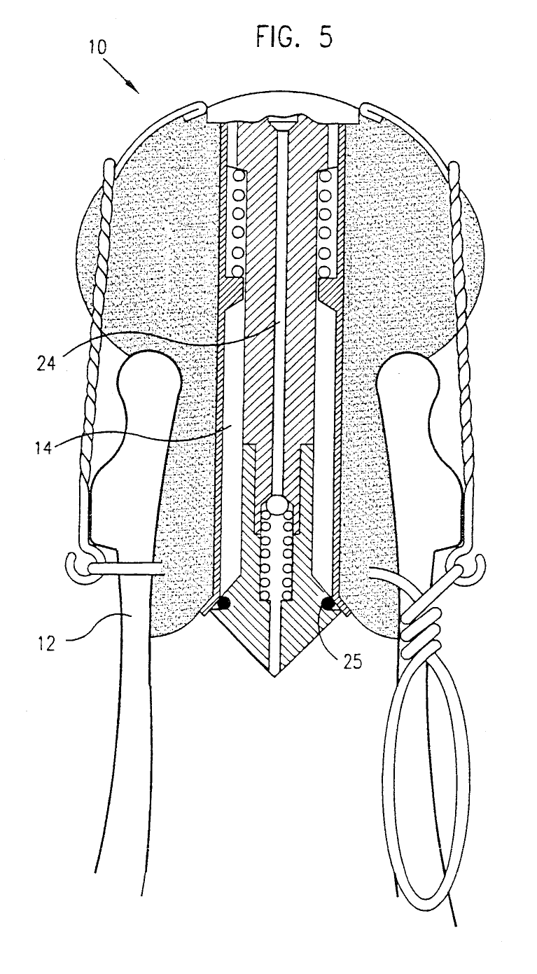

As seen in FIG. 4, plunger 22 may be selectively pushed generally in the direction of an arrow 42 to allow collected sediments to flow into bore 14, flow past distal and proximal rings 38 and 40, and be expelled from bottle 12 generally in the direction of arrows 44. When plunger 22 is pushed in the direction of arrow 42, biasing device 36 is compressed. After the sediments have been propelled out of the bottle by the internal pressure of the contents of the bottle, the internal pressure and biasing device 36 urge plunger 22 in the opposite direction of arrow 42 and O-ring 25 re-seals plunger 22 against valve seat 17. As seen in FIG. 5, after expulsion of sediments, rupturable head 23 may be severed or sheared off plunger 22.

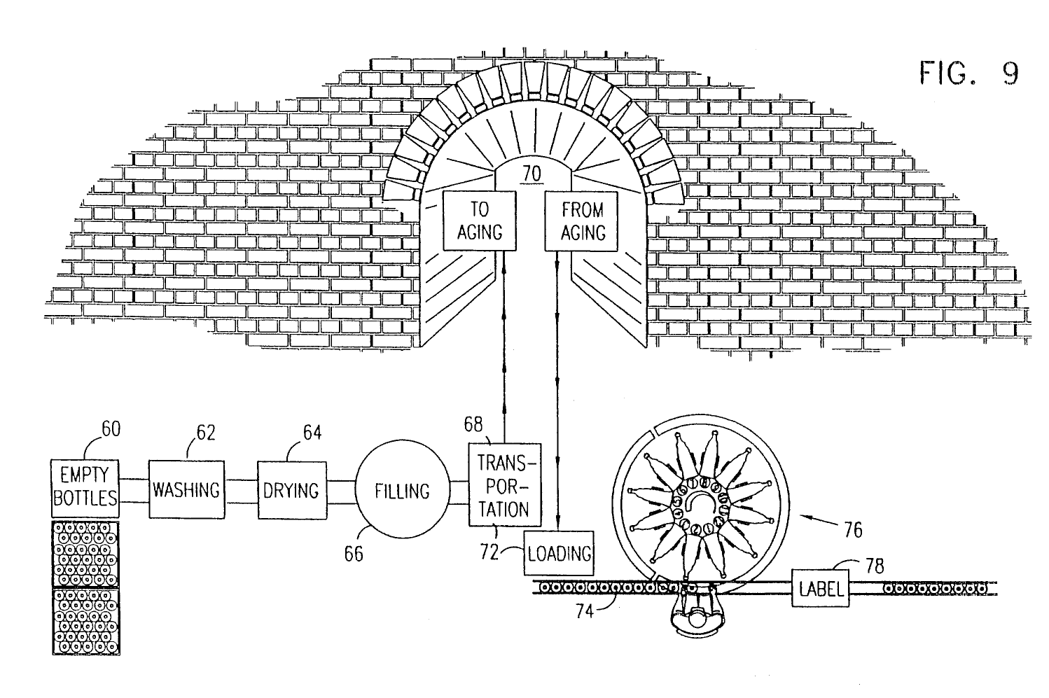

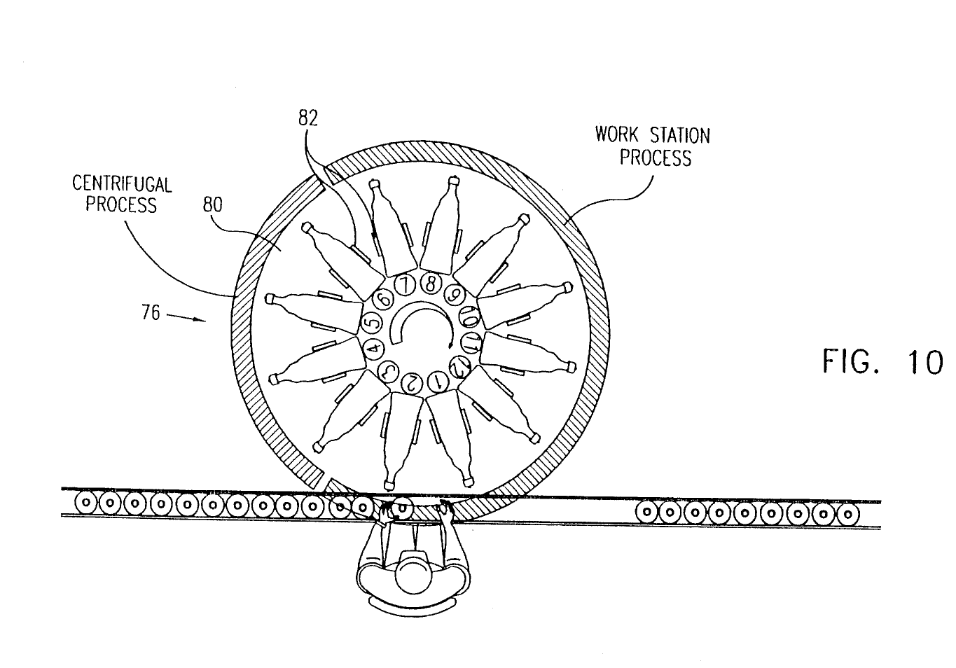

Reference is now made to FIG. 6 which illustrates adding a substance to the wine in bottle 12 in accordance with a preferred embodiment of the invention. In a method for production-line processing wine in accordance with a preferred embodiment of the present invention, described hereinbelow in detail with reference to FIGS. 9-18, the substance is added after shearing rupturable head 23 off plunger 22. However, it is appreciated that the substance could also be added before shearing rupturable head 23 off plunger 22, as is illustrated in FIG. 6.

A stream of a substance injected by syringe 32 presses ball 26 against spring 28, thereby creating a gap between ball 26 and valve seat 30 and allowing the substance to be introduced through a distal end 34 of passageway 24. The stream of substance is preferably injected at high pressure to overcome both the pressure of spring 28 and the internal pressure of the fluid that may be applying pressure to the distal end 34 of passageway 24. This internal pressure plus the force of biasing device 36 act against the force of syringe 32 and the stream of the substance so as to maintain plunger 22 sealed against valve seat 17.

Alternatively, syringe 32 may be fashioned so that a distal end thereof touches and presses ball 26 against spring 28. As a further alternative, syringe 32 may be built into stopper 10, the syringe containing a predetermined dose of liqueur or other substance, wherein a user may then inject the predetermined dose into the bottle. Ball 26 and valve seat 30 thus form an internal valve for controlled passage of substances therethrough, regardless if valve 20, which acts as a main valve, is closed or not.

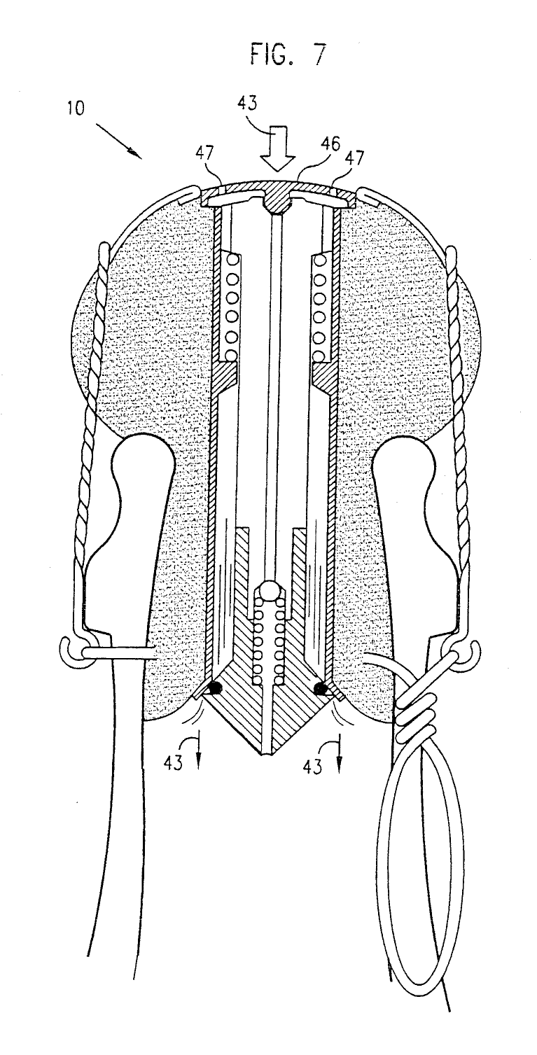

Afterwards, as seen in FIG. 7, a cap 46 may be secured to the top portion of plunger 22 for aesthetic purposes. Cap 46 is preferably formed with one or more apertures 47. Before opening the bottle, cap 46 can be pressed downwards generally in the direction of arrows 43 so as to move plunger 22 away from valve seat 17, thereby expelling gases through apertures 47. The expelling of the gases can prevent a possible violent “popping” of the stopper when opening the stopper.

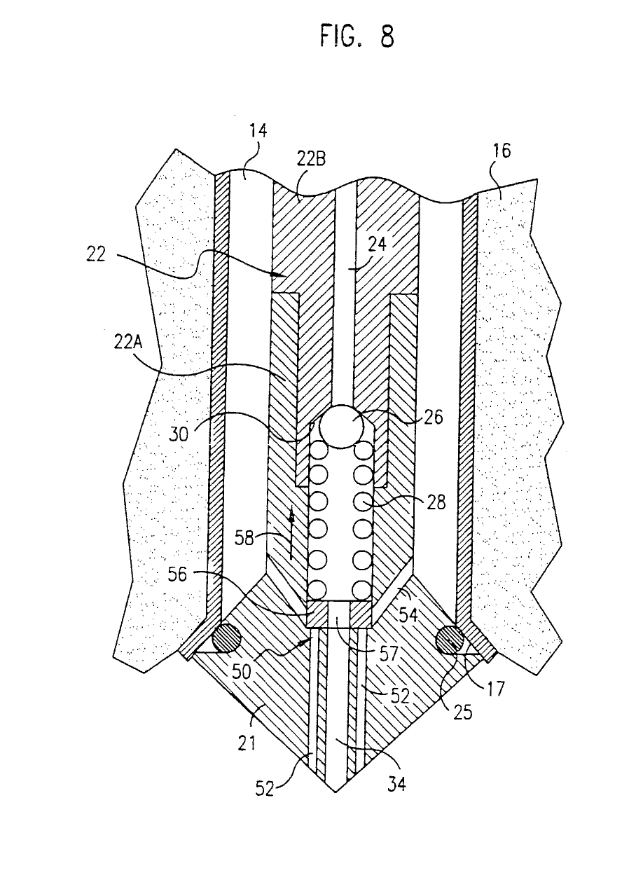

Reference is now made to FIG. 8 which illustrates a pressure relief valve 50 useful in stopper 10. Pressure relief valve 50 preferably includes one or more holes or channels 52 (two channels 52 in the illustrated embodiment) formed in end 21 of plunger 22. Channels 52 are open at the tip of end 21 and are preferably positioned on sides of distal end 34 of passageway 24. Each channel 52 preferably extends into a hole or passageway 54 which is open to bore 14. A sealing washer 56 is preferably normally seals channels 52 from passageways 54 and is urged against the junctions of channels 52 and passageways 54 by the action of spring 28. It is noted that sealing washer 56 preferably has a central hole 57 to allow free passage therethrough of any substances which might be introduced into bottle 12, as described above with reference to FIG. 6.

The operation of pressure relief valve 50 is now described. Normally, sealing washer 56 substantially prevents flow of matter into passageways 54. Excess pressure formed inside bottle 12 may push against sealing washer 56 and, if of sufficient magnitude, may move sealing washer 56 against spring 28 in the direction of an arrow 58. If sufficient pressure causes sealing washer 56 to move in the direction of arrow 58, matter can flow through channels 52, passageways 54 and bore 14, and be expelled from the top of stopper 10, thereby relieving the internal pressure formed in bottle 12. Pressure relief valve 50 relieves this pressure with O-ring 25 still sealingly seated against valve seat 17. It is noted that alternatively a pressure relief valve may be located on any other portion of stopper 10 or bottle 12.

Reference is now made to FIG. 9 which illustrates in block diagram form a method for production-line processing wine in accordance with a preferred embodiment of the present invention. Empty bottles are placed on a conveyor belt at a station 60. The bottles are conveyed to a washing station 62 where the bottles are washed. The bottles are then conveyed to a drying station 64 where the bottles are dried. Afterwards the bottles are conveyed to a filling station 66 where the bottles are filled with wine and capped with stopper 10 described hereinabove with reference to FIGS. 1-8. It is noted that up to station 66, the process can utilize standard, existing equipment of the art, without any need for changing existing infrastructure of wineries. At station 66, the only change to existing equipment would be to adapt the existing machine that puts the stoppers on the bottles to enable the machine to place the stoppers of the present invention on the bottles.

At a station 68, the bottles are placed in boxes or crates and transported either by conveyor belt, monorail or fork-lift trucks to an aging cellar 70. In the present invention, it does not matter how the bottles are conveyed to and from aging cellar 70. However, in the prior art which uses riddling machines, the bottles must be placed in cages used for riddling machines when being conveyed from aging cellar 70 to those riddling machines.

After aging, which usually takes about a minimum of one and a half years, the bottles are conveyed from the wine cellar 70, either in-line by conveyor belt or monorail, or in crates by fork-lift trucks, for example, to a loading station 72. At station 72, the bottles are loaded onto a conveyor belt 74. This may be done by a variety of loading mechanisms well known in the conveying art and which need no further description for the skilled artisan. Of course, alternatively the bottles may be manually loaded onto the conveyor belt 74. In the event that the bottles are conveyed from the wine cellar 70 by a convey or belt, loading of the bottles onto conveyor belt 74 is rather no straightforward, as is well appreciated by the skilled artisan. In the event of fork-lift transportation of the bottles, the bottles must of course be first unloaded from the crates or boxes and then loaded onto conveyor belt 74.

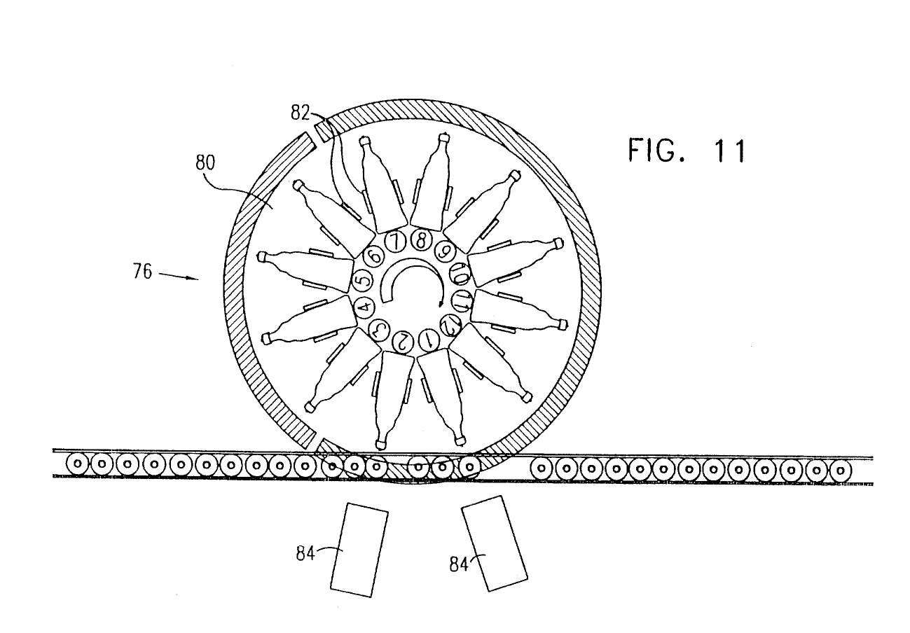

Conveyor belt 74 conveys the bottles to a sediment removal machine 76, which is described further hereinbelow in detail with reference to FIGS. 10-18. After sediments have been removed from the wine and expelled from the bottles, as is described further hereinbelow, the bottles move on conveyor belt 74 to a label station 78 for placing wrappers, labels and the like on the bottles. The bottles are then ready for shipment to consumers.

The construction and operation of sediment removal machine 76 are important aspects of the present invention and are key factors in realizing significant cost and time savings over the methods of the prior art. The construction and operation of sediment removal machine 76 are now described with reference to FIGS. 10-18.

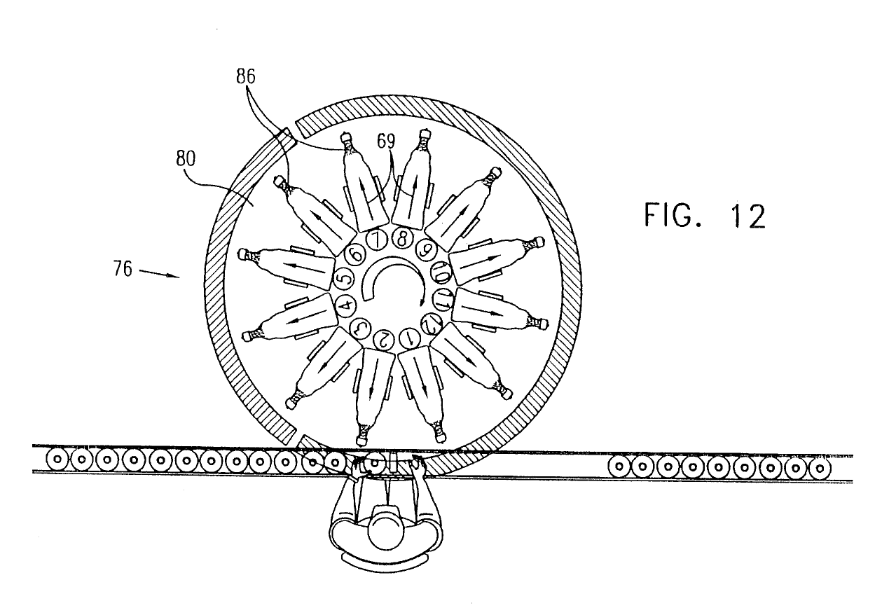

Sediment removal machine 76 includes a centrifuge machine (e.g., centrifuge table) 80 formed with a plurality of bottle receiving members 82 that securely hold the bottles on machine 80 during high-speed rotation of machine 80. Centrifuge machine 80 may be horizontal, vertical or at any angle. Bottle receiving members 82 securely hold the bottles lying flat on machine 80, with the bottle stoppers of the bottles pointing radially outwards from a center of machine 80. As one example, bottle receiving members 82 may include conical depressions formed in machine 80 that securely hold the bottles in place. Apparatus for holding bottles in place is well known in the art and does not need further description for the skilled artisan. In FIG. 10, the bottles are moved manually from conveyor belt 74 onto machine 80. Alternatively, as shown in FIG. 11, the bottles may be fed from conveyor belt 74 onto machine 80 and removed from machine 80 after finishing, by one or more manipulators 84. In the illustrated embodiment, there are twelve bottle receiving members 82 for holding twelve bottles at a time on machine 80, and two bottles may be loaded on and unloaded from machine 80 at a time. However, it is appreciated that this is just one example of carrying out the invention, and that any other number of bottles may be handled by machine 80. In addition, stacks of machines 80 may be employed for increasing the production rate.

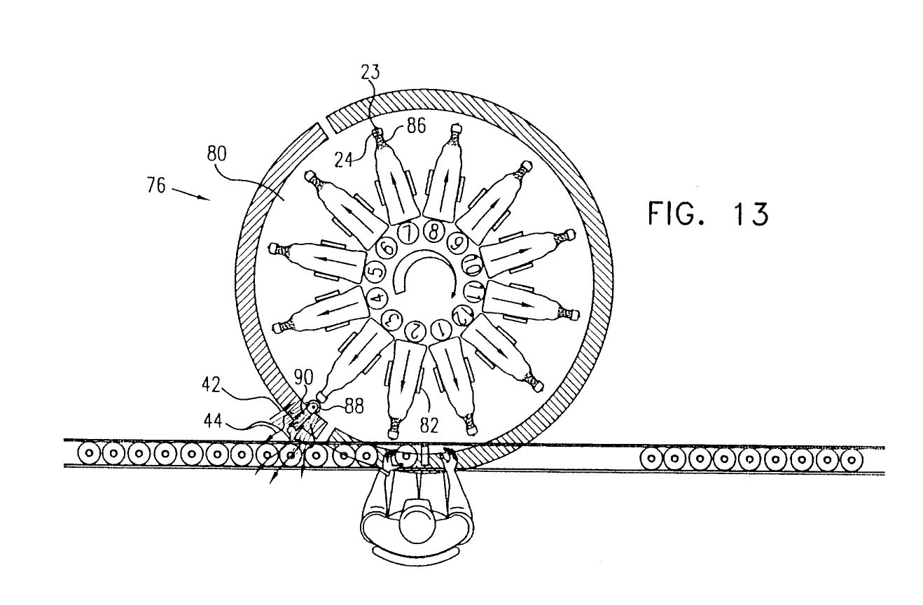

After the bottles are loaded, machine 80 is rotated at high-speed, as shown in FIG. 12, in order to centrifuge sediments 86 that have been formed in the bottles during aging in cellar 70. Sediments 86 are forced towards stopper 10 and collect in the vicinity of end 21 of plunger 22, as seen in FIG. 1, and as shown by arrows 69 in Fi. 12.

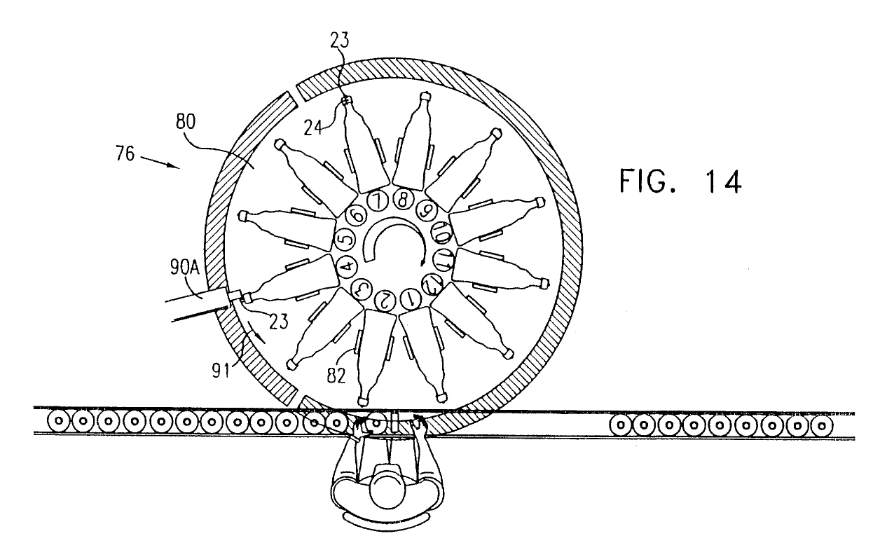

After centrifuging, a slider 88, manipulated by an actuator 90 of sediment removal machine 76, is moved against plunger 22, as shown in FIG. 13. For purposes of clarity, actuator 90 and slider 88 are shown only in FIG. 13, but it is appreciated that they are positioned near the bottle stoppers, and that actuator 90 moves and maintains slider 88 against plunger 22 only when needed at the proper timing, such timing being controlled by appropriate control systems (not shown). For example, slider 88 and actuator 90 may be positioned overhead the bottle stoppers and slider 88 may be brought into position when necessary. As shown and described above with reference to FIG. 4, slider 88 moves plunger 22 in the direction of arrow 42 to allow collected sediments 86 to flow into bore 14, flow past distal and proximal rings 38 and 40, and be expelled from stopper 10 generally in the direction of arrows 44. The sediments 86 are propelled out of the bottle by the internal pressure in the bottle and by the centrifugal force. As machine 80 rotates, all of the bottles move past slider 88. Slider 88 sequentially pushes in the plungers 22 of each bottle as the bottles move therepast, and the sediments 86 are sequentially and rapidly expelled from all of the bottles, typically in a fraction of a second. The bottles may be moved past slider 88 not just once, but several times during rotation of machine 80 to ensure full expulsion of the sediments 86, if desired. The expelled sediments may be collected for further use, if desired. (Another embodiment will be described further hereinbelow, in which the sediments are collected and trapped within the stopper itself.)

After expulsion of sediments, another pin 92, manipulated by actuator 90 or another actuator 90A of sediment removal machine 76, is moved in relation to rupturable head 23 such that as machine 80 rotates, pin 92 strikes rupturable head 23, thereby shearing rupturable head 23 off plunger 22, as shown by an arrow 91 in FIG. 14, and as is described hereinabove with reference to FIG. 5. For the purposes of clarity, FIG. 14 shows rupturable head 23 being sheared off only one of the bottles. As machine 80 rotates, all of the bottles move past pin 92. Pin 92 sequentially shears off heads 23 as the bottles move therepast.

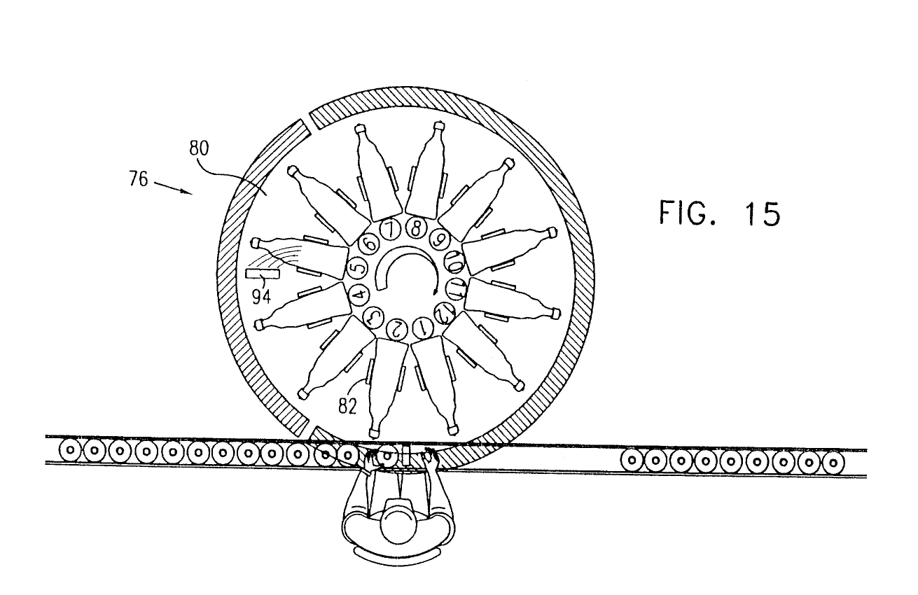

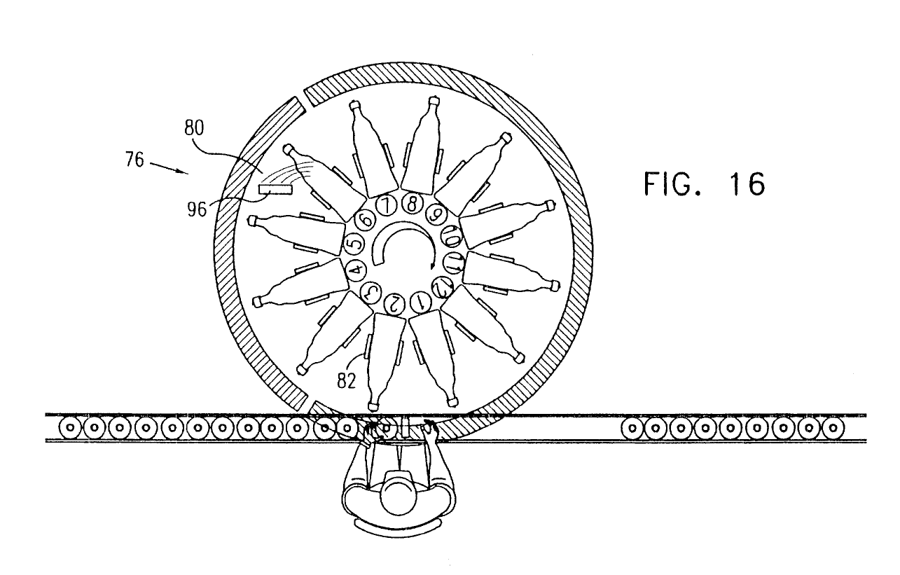

Reference is now made to FIGS. 15 and 16 which respectively show that the bottles are now washed and dried. For example, wash spray heads 94 wash and rinse the bottles (FIG. 15) and warm, air flow heads 96 dry the bottles with a stream of warm air (FIG. 16). The bottles are preferably washed and dried as machine 80 rotates. Up to this point, machine 80 has acted as a centrifuge or rotating machine. Machine 80 will now act as a workstation instead of as a rotating machine.

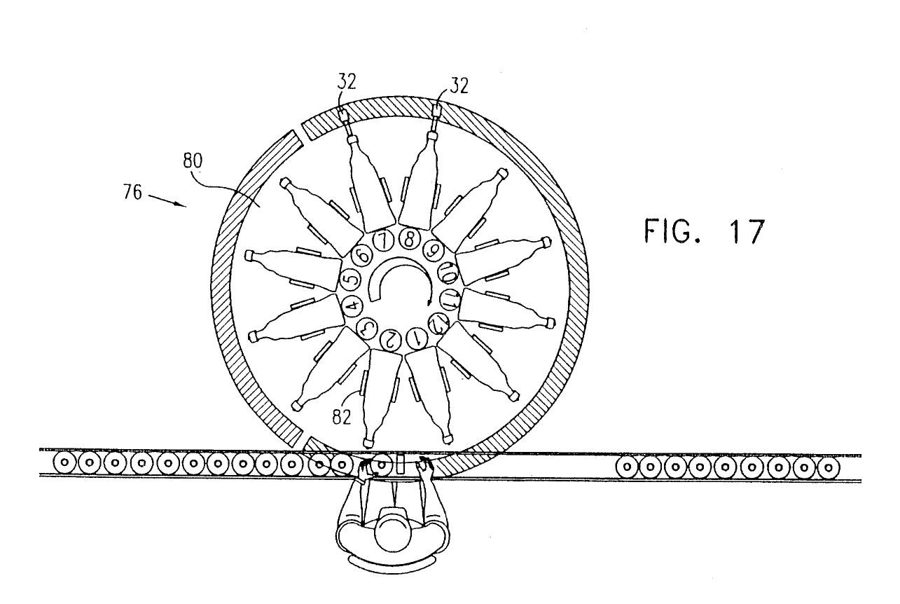

Reference is now made to FIG. 17 which illustrates adding a substance, such as brandy, sugar or flavorings, for example, to the bottles. Addition of the substance is preferably as described hereinabove with reference to FIG. 6, wherein syringe 32 presses ball 26 against spring 28, thereby creating a cap between ball 26 and valve seat 30 and allowing the substance to be introduced through a distal end 34 of passageway 24. Syringe 32 may be provided for one, some or all of the bottles at a time. Preferably the control system of sediment removal machine 76 controls the metering of the substance to the bottles.

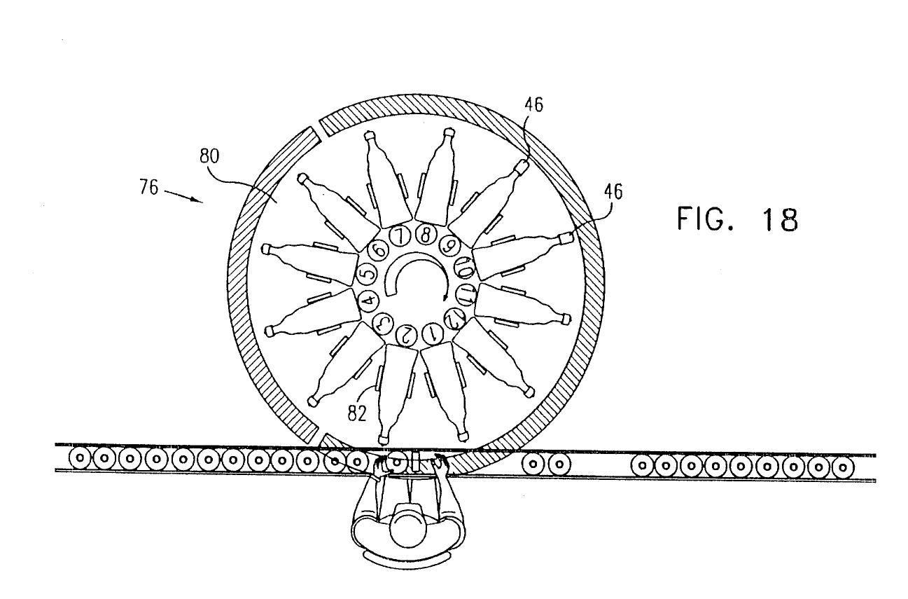

Reference is now made to FIG. 18. After adding the substance, cap 46 may be secured to the top portion of stopper 10 for aesthetic purposes, as described hereinabove with reference to FIG. 7. Cap 46 may be secured by means of conventional capping machinery well known in the art. As mentioned above, the bottles then move on conveyor belt 74 to a label station 78 for placing wrappers, labels and the like on the bottles. The bottles are then ready for shipment to consumers. Again as mentioned above, the bottles may be moved on conveyor belt 74 either manually or automatically, at any number at a time.

It is readily appreciated that sediment removal machine 76 is provided with any necessary sensors, control equipment, central processors and the like, for controlling the above described process.

The entire process of sediment removal machine 76 typically takes about 1.5 minutes. In the case of the illustrated embodiment, this amounts to a production rate of 480 bottles an hour, 11520 bottles per 24 hours, and about 4,000,000 bottles per year. For a three-tiered table, the production rate would triple to 12,000,000 per year. These production rates are a prodigious improvement over the prior art.

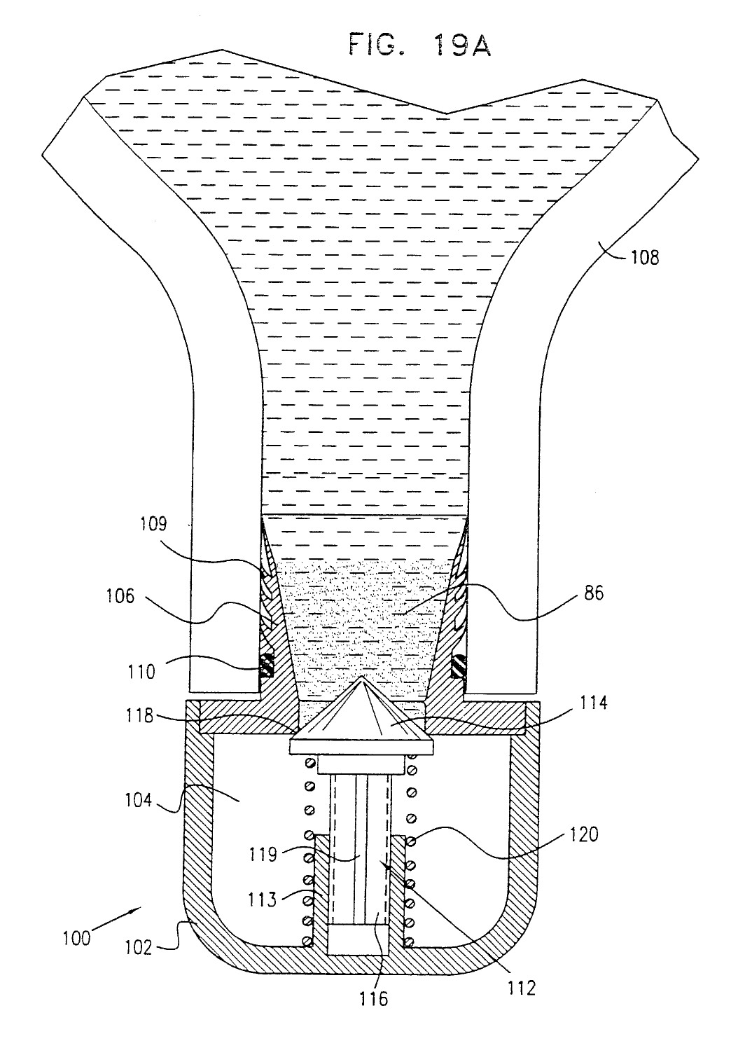

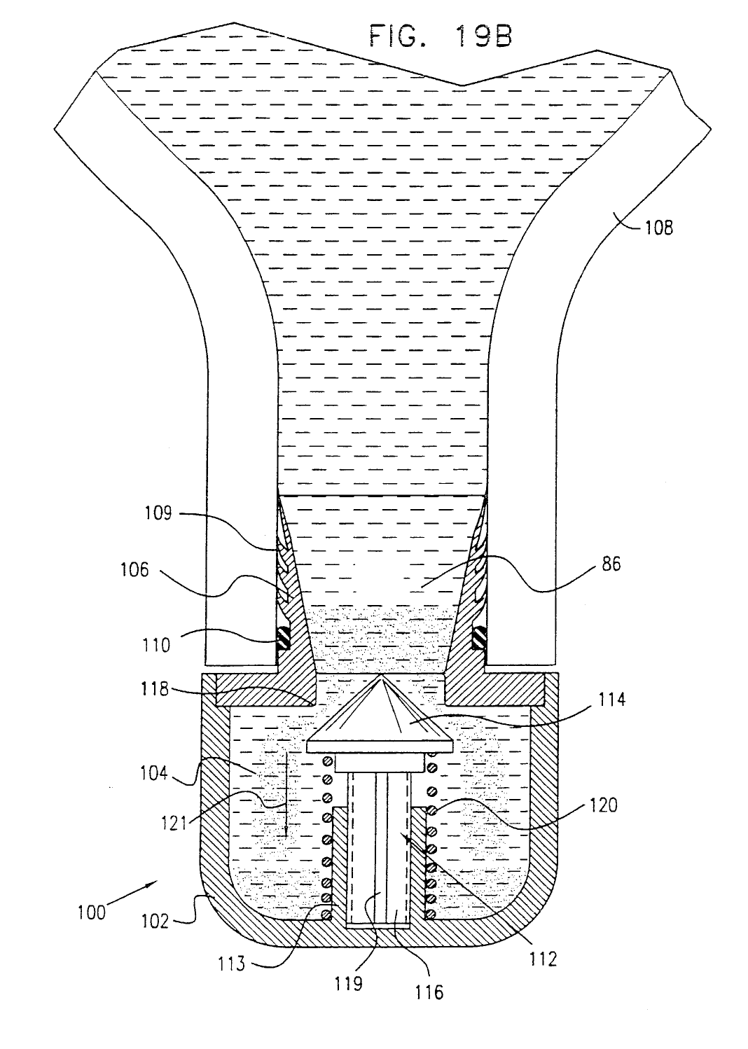

Reference is now made to FIGS. 19A, 19B and 19C which illustrate a stopper 100. constructed and operative in accordance with an alternative embodiment of the present invention. Stopper 100 preferably includes a collection receptacle 102 which defines a volume 104 for collecting and trapping therein sediments. Stopper 100 preferably has a stem 106 (formed separately and attached to collection receptacle 102, or made integrally therewith) that fits into the neck of a bottle 108. An O-ring 110 preferably seals stem 106 with bottle 108. Alternatively, stem 106 may be formed with radial extensions 109 that effect a seal with bottle 108. A plunger 112 is preferably slidingly disposed in a guide member 113 formed in collection receptacle 102. Plunger 112 preferably includes an end member 114, preferably, but not necessarily, conically shaped, disposed at the end of a shaft 116. End member 114 is preferably adapted to sealingly seat against a valve seat 118 formed at a throat of stem 106. Shaft 116 is preferably formed with one or more axial grooves 119 so that air can freely pass from guide member 113 past grooves 119 into volume 104. Plunger 112 is preferably biased against the inside of collection receptacle 102 by means of a biasing device 120, such as a spring.

In FIG. 19A, sediments 86 have collected near end member 114 of plunger 112, preferably by means of the centrifugal force imparted thereto by centrifuge machine 80, described hereinabove with reference to FIGS. 10-18. Centrifuge machine 80 starts accelerating the bottles, as described above, and eventually reaches an acceleration that not only forces sediments 86 towards stopper 100, but also imparts a force on end member 114 of plunger 112 sufficient to overcome the force of biasing device 120 and move end member 114 away from seat 118 in the direction of an arrow 121, as seen in FIG. 19B. Since plunger 112 has been moved away from seat 118, sediments 86 are forced into the volume 104 of collection receptacle 102. Afterwards centrifuge machine 80 is slowed down, and in the presence of a reduced rotational speed, biasing device 120 overcomes the centrifugal force and moves end member 114 back against seat 118, thereby sealing and trapping sediments 86 in volume 104 of collection receptacle 102, as seen in FIG. 19C. It is readily understood that stopper 100 can be conveniently used in the present invention instead of stopper 10.

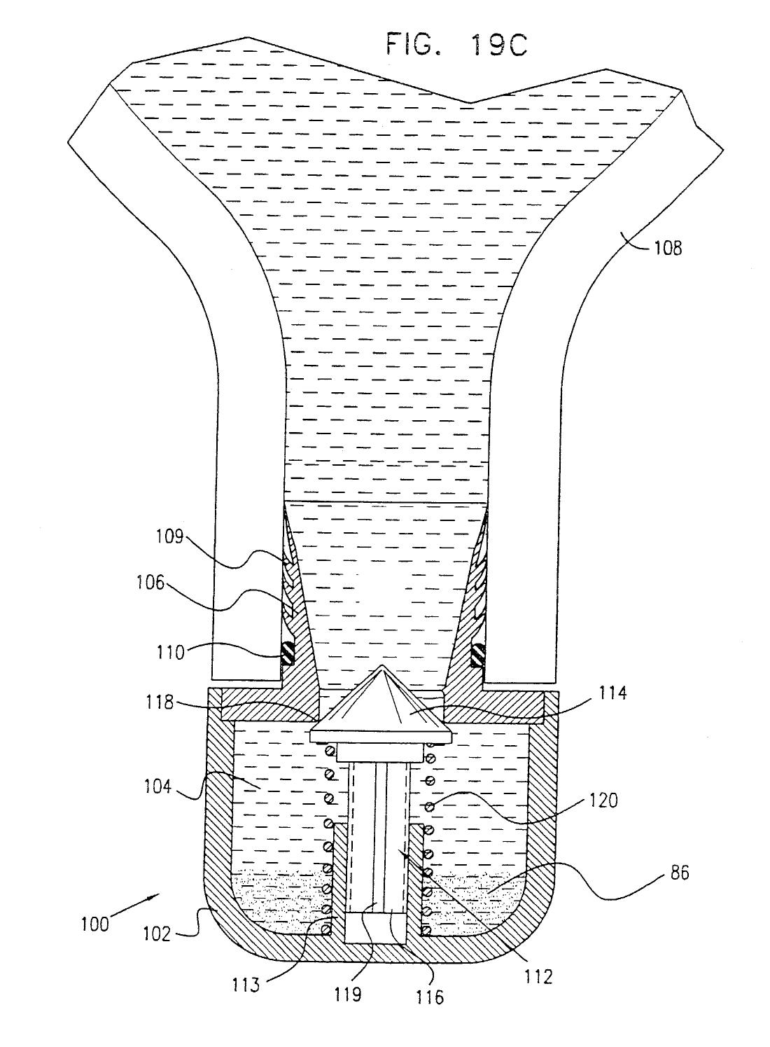

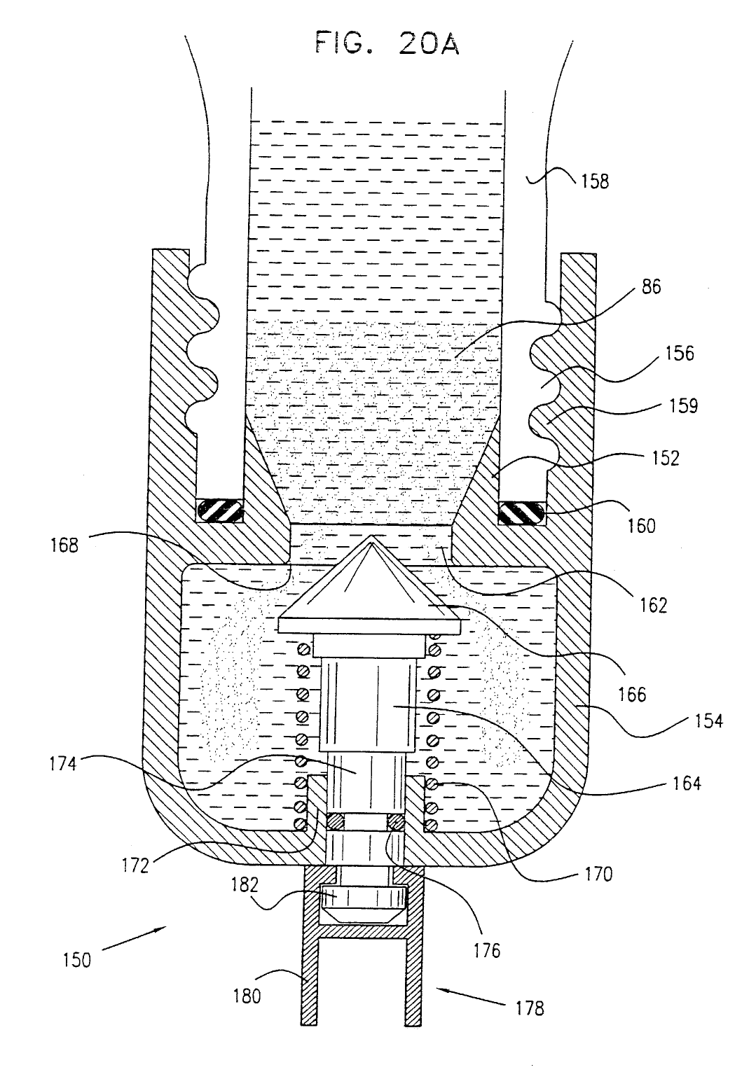

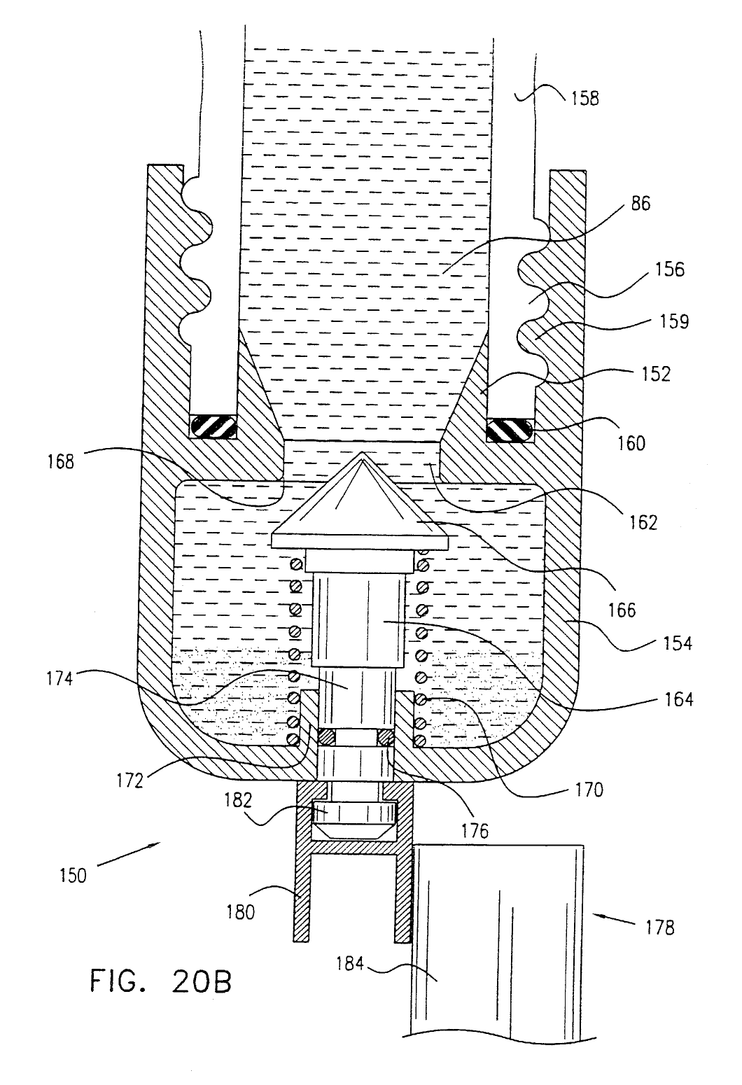

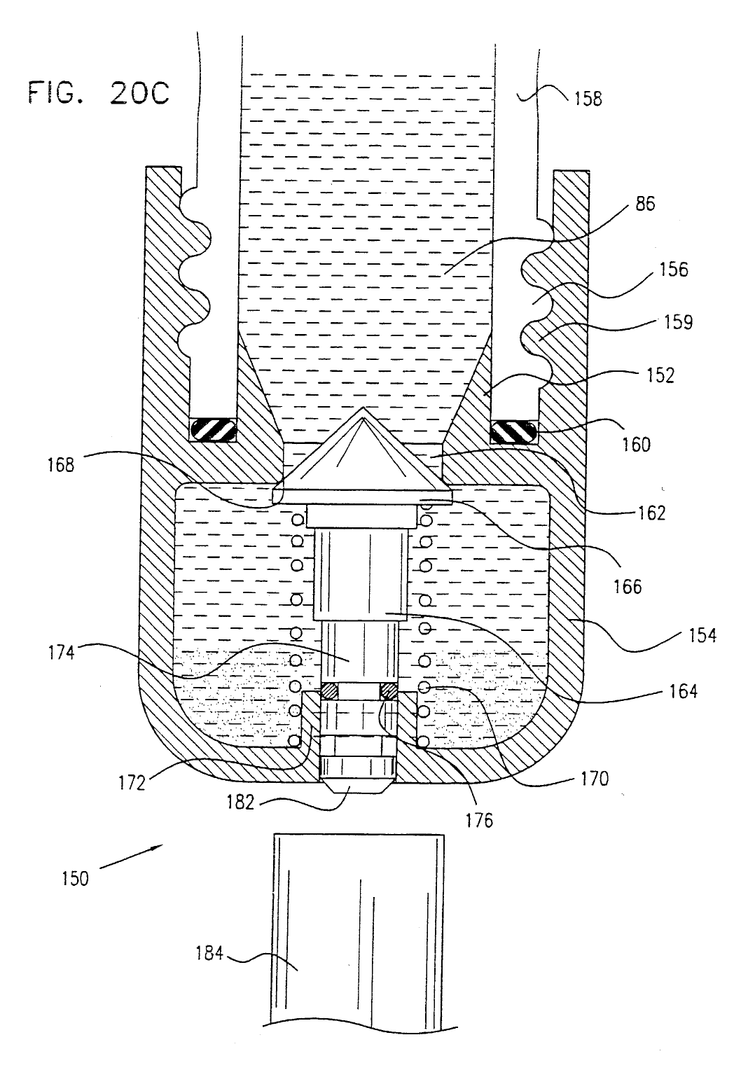

Reference is now made to FIGS. 20A, 20B and 20C which illustrate a stopper 150. constructed and operative in accordance with another alternative embodiment of the present invention. Stopper 150 preferably includes a stem 152 that extends from a collection receptacle 154. Stem 152 is typically generally cylindrical in shape and adapted to sealingly fit into a neck 156 of bottle 158. Stem 152 is preferably sealed with respect to neck 156 by any conventional sealing device. For example, stopper 150 may be threaded, preferably being provided with male threads 159. Bottle 158 is preferably correspondingly threaded so that stopper 150 may be screwed onto bottle 158. A seal, such as an O-ring 160, may be used to effect a seal between stopper 150 and bottle 158. Stem 152 preferably has a bore 162 to permit fluid communication between contents of bottle 158 and collection receptacle 154.

A plunger 164 is preferably disposed in collection receptacle 154 and formed with an end 166 which may sealingly seat against a valve seat 168 at an end of bore 162 in stem 152. End 166 is typically conical in shape, but it is appreciated that other shapes may also be used that sealingly seat against valve seat 168. Plunger 164 may be biased by any biasing device, such as a spring 170. Plunger 164 is preferably arranged for generally linear movement inside receptacle 154. Preferably receptacle 154 has an inwardly protruding sleeve 172 in which a shaft portion 174 of plunger 164 slides. Shaft portion 174 is preferably provided with an O-ring 176 so as to provide a substantially sealed interface between shaft portion 174 and sleeve 172.

FIG. 20A illustrates stopper 150 in an open configuration wherein contents of bottle 158 may flow into receptacle 154. Preferably stopper 150 employs a retaining mechanism 178 to remain in the open configuration. Retaining mechanism 178 may include a keeper 180 which engages with a knob 182 formed at an end of plunger 164 opposite to end 166. In FIG. 20A, sediments 86 have begun to flow into receptacle 154, due to the centrifugal force of centrifuge machine 80, as described hereinabove. In FIG. 20B, the centrifugal force has forced all of the sediments 86 into receptacle 154. In FIG. 20C, a slider 184 of sediment removal, machine 76 (FIGS. 10-18) has pushed keeper 180 off knob 182. This spring 170 urges end 166 of plunger 164 to sealingly seat against valve seat 168, thereby trapping collected sediments 86 inside receptacle 154. It is appreciated that keeper 180 is merely one example of retaining mechanism 178, and many variations are possible, such as a pin releasably fitted into a hole underneath knob 182. It is noted that in the embodiment of FIGS. 20A-20C, the pressure inside bottle 158 and receptacle 14 is generally the same.

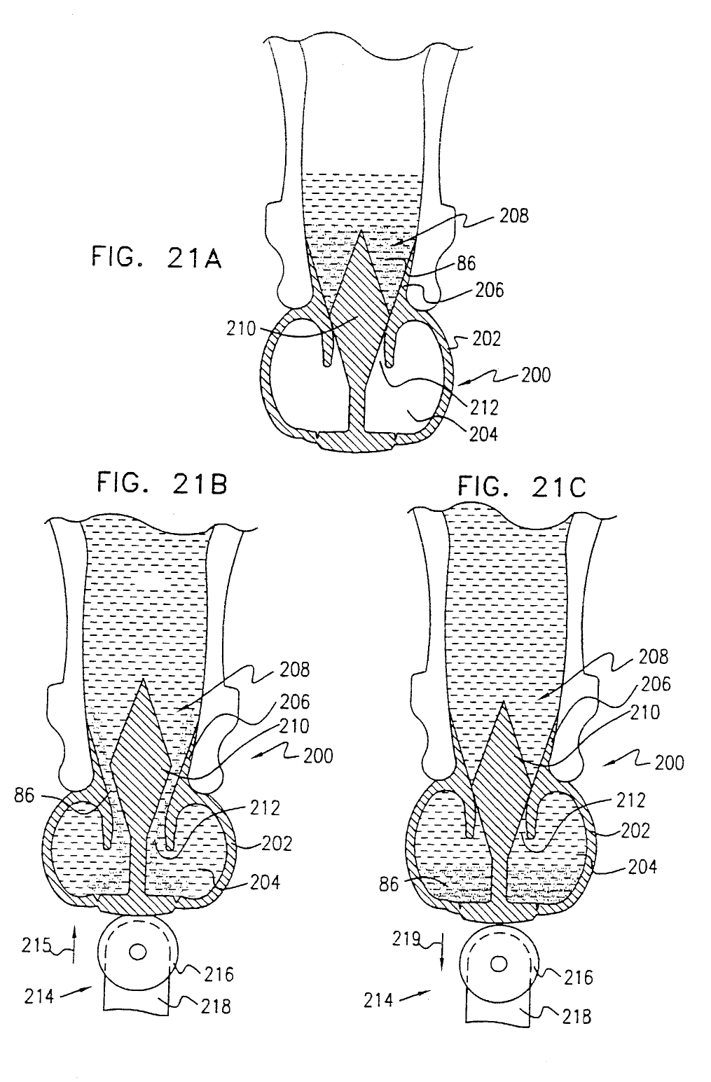

Reference is now made to FIGS. 21A, 21B and 21C which illustrate a stopper 200 constructed and operative in accordance with still another preferred embodiment of the present invention. Stopper 200 is preferably formed with a flexible and expandable collection receptacle 202, defining an internal volume 204, and a bottle-insertion portion 206. Expandable collection receptacle 202 is typically formed or molded from a plastic, and may be either integrally formed with or attached to bottle-insertion portion 206. Stopper 200 also preferably includes a valve 208 that preferably includes a tongue 210 which extends from expandable collection receptacle 202 and protrudes into and through a mouth 212 of bottle-insertion portion 206.

In FIG. 21A, sediments 86 have collected near tongue 210, preferably by means of the centrifugal force imparted thereto by centrifuge machine 80, described hereinabove with reference to FIGS. 10-18. In FIG. 21B, a slider 214 of sediment removal machine 76 is pushed against collection receptacle 202 generally in the direction of an arrow 215. Slider 214 preferably includes a flexible roller 216 rotatingly mounted on a shaft 218. The action of slider 214 pushing against collection receptacle 202 expands collection receptacle 202 and moves tongue 210 away from the walls of stem 206. Sediments 86 are now free to flow into collection receptacle 202 via mouth 212. In FIG. 21C, slider 214 is moved generally in the direction of an arrow 219 away from collection receptacle 202. Collection receptacle 202 springs back generally to its original form and tongue 210 is resealed against the walls of stem 206. It is noted that the centrifugal force of centrifuge machine 80 plus the fluid pressure in expandable collection receptacle 202 plus the internal pressure of the bottle help collection receptacle 202 to expand generally back to its original form, and tongue 210 to abut against the walls of stem 206, thereby substantially trapping sediments 86 therein.

It is appreciated that the stoppers of FIGS. 19A-C, 20A-C and 21A-C may be optionally provided with a pressure relief device, a fitting for adding additives, and a cap with apertures, generally as described hereinabove for stopper 10.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

What is claimed is:

1. method for processing wine, comprising:
filling a bottle with wine;
capping said bottle with a bottle stopper, said bottle stopper including a valve that has a first orientation in which sediments can flow from said bottle past said valve, and a second orientation in which the valve substantially prevents re-entry of the sediments back into said bottle;
producing sediments in said bottle;
centrifugally forcing the sediments in said bottle towards said bottle stopper, said valve being in the first orientation so that the sediments flow past said valve and are removed from said bottle; and
moving said valve to said second orientation to substantially prevent re-entry of the sediments back into said bottle.

2. The method according to claim 1 wherein said valve comprises a collection receptacle and in said second orientation said valve traps the sediments in said collection receptacle.

3. The method according to claim 1 wherein said valve permits expelling the sediments out of said bottle without collecting the sediments in said valve.

4. The method according to claim 1 and further comprising adding additives to said wine without removing said bottle stopper from said bottle.

5. The method according to claim 1 and further comprising shearing off a rupturable head from said bottle stopper after the sediments have been removed from said bottle.

6. The method according to claim 5 and further comprising placing a final cap on said bottle stopper after shearing off the rupturable head.

7. The method according to claim 6 and further comprising placing a label on said bottle.

8. A sediment removal machine comprising:
a centrifuge machine; and
a plurality of bottle receiving members operative to securely hold a plurality of bottles lying flat on said machine during high-speed rotation of said machine, with bottle stoppers of the bottles pointing radially outwards from a center of said machine.

9. The sediment removal machine according to claim 8 and further comprising a plurality of bottles which are held on said machine by said bottle receiving members.

10. The sediment removal machine according to claim 9 wherein each of said bottles comprises a bottle stopper, said stopper comprising a valve that has a first orientation in which sediments can flow from said bottle past said valve, and a second orientation in which the valve substantially prevents re-entry of the sediments back into said bottle.

11. The sediment removal machine according to claim 10 wherein said bottle stopper comprises a pressure relief valve.

12. The sediment removal machine according to claim 10 and further comprising an actuator operative to move said valve to at least one of said first and second orientations.

13. The sediment removal machine according to claim 10 and further comprising apparatus for shearing off a rupturable head off said bottle stopper.

14. The sediment removal machine according to claim 8 and further comprising apparatus for washing said bottles.

15. The sediment removal machine according to claim 8 and further comprising apparatus for drying said bottles.

16. The sediment removal machine according to claim 10 and further comprising apparatus for adding a substance to said bottles without removing said stopper from said bottle.

17. The sediment removal machine according to claim 8 and further comprising apparatus for adding a cap to said bottles.

18. A bottle stopper comprising:
a collection receptacle that defines a volume for collecting and trapping therein sediments;
a stem extending from said collection receptacle adapted to fit into a neck of a bottle, said stem being formed with a valve seat; and
a plunger slidingly disposed in a guide member formed in said collection receptacle, said plunger including an end member disposed at an end of a shaft, said end member being arranged to sealingly seat against said valve seat, said shaft being formed with at least one axial groove so that air can freely pass from said guide member past said at least one groove into said volume.

19. The stopper according to claim 18 wherein said plunger is biased against an inside surface of said collection receptacle by means of a biasing device.

20. A bottle stopper comprising:
a stem that can be sealingly inserted into a neck of a bottle, said stem comprising a valve seat formed at an end of a bore;
a valve comprising a plunger disposed in said bore, said plunger being arranged to be selectively seated against said valve seat, said plunger being operative to substantially prevent passage of matter into said bore when seated against said valve seat, and to permit passage of matter into said bore when not seated against said valve seat; and
a pressure relief valve having a channel open at an end of said plunger that extends into a passageway which fluidly communicates with said bore, said pressure relief valve comprising a sealing washer positioned between said channel and said passageway, said sealing washer permitting passage of matter from said channel to said passageway only when a pressure of a sufficient magnitude is applied thereagainst.

21. The stopper according to claim 20 and further comprising a cap affixed to a top portion of said plunger, said cap being formed with at least one aperture in fluid communication with said bore, wherein said cap can be pressed to move said plunger away from said valve seat, thereby permitting egress of matter through said bore and said at least one aperture.
